(19) United States
(12) Patent Application Publication
(10) Pub. No.: US 2010/0162388 A1
(43) Pub. Date: Jun. 24, 2010

(54) Wireless mobile device with automatic segregation of received messages for private and public access

(76) Inventors: Ernest Samuel Baugher, Buda, TX (US); Venkata Chalapathi Majeti, Naperville, IL (US)

Correspondence Address: Carmen Patti Law Group , LLC, ONE N. LASALLE STREET, 44TH FLOOR, CHICAGO, IL, 60602, US

(21) Appl. No.: 12/584,423

(22) Filed: Sep. 4, 2009

Related U.S. Application Data
(63) Continuation-in-part of application No. 12/317,187, filed on Dec. 19, 2008.

(51) Int. Cl. H04L 9/32; G06F 21/00

(52) U.S. Cl. 726/19; 726/28

(57) ABSTRACT

An exemplary method is implemented by a wireless mobile device that transmits and receives text-based messages. Received messages are stored in memory of the wireless mobile device. Based on a privacy criteria stored in the memory, some of the received messages are automatically identified as public and others of the received messages are automatically identified as private. Access is provided to stored received messages that are designated as public to any user of the mobile device. Access is provided to stored received messages that are designated as private only after receipt of a password entered by a user of the wireless mobile device that permits access to the privately identified messages.

### CROSS REFERENCE TO RELATED APPLICATION

This is a continuation-in-part application that claims the benefit of the prior filed U.S. patent application Ser. No. 12/317,187 filed Dec. 19, 2008 entitled “WIRELESS MOBILE DEVICE WITH PRIVACY GROUPS THAT INDEPENDENTLY CONTROL ACCESS TO RESIDENT APPLICATION PROGRAMS” that claimed the benefit of the prior filed U.S. patent application Ser. No. 12/220,135 filed Jul. 22, 2008, all of which are incorporated herein. This application is related to the concurrently filed application, “MOBILE DEVICE WITH SEPARATE ACCESS TO PRIVATE AND PUBLIC INFORMATION STORED IN THE DEVICE”.

### BACKGROUND

This invention relates segregation to wireless mobile communication devices capable of receiving and transmitting text-based messages. It is especially, but not exclusively, directed to providing automatic separation and access control of stored messages based on whether the addressee of a transmitted message or the originator of a received message is a public or private contact.

Cellular telephones that are multimedia message service (MMS) and/or SMS capable can run a variety of resident application programs beyond basic voice communications. Functions such as address books, contact lists, and text messaging applications are each typically represented by icons displayed on the screen of the cellular telephone or personal digital assistant. To access a particular function, the user can highlight or point and click on an icon displayed on the screen associated with the function/application desired to be accessed. Once a user has the ability to access and operate the device, the user has access to all the information stored on the device even if the user is not the owner (normal user) of the device. For example, a guest user can access and view the owner's list of contacts stored in the device's contact database along with all contact information stored for each person in the contact database. And the guest user can access and view all messages stored in the device's inbox and outbox (sent messages). Although the owner may desire to allow temporary usage of the device by a guest such as to make a telephone call or send a text-based message, confidential information of the owner that is stored in the device may intentionally or unintentionally viewed by the guest user.

### SUMMARY

An object of the present invention is to provide the owner of the mobile device with privacy by which a guest user can be granted permission to temporarily operate the device including access to stored messages designated as public but is prevented from accessing stored messages designated as private.

A further object is to automatically segregate and store received messages in a public inbox, a private inbox, or both based on whether the originator of the received message is a public or private contact and/or whether the content of the message is encrypted or to be treated as confidential.

An exemplary method is implemented by a wireless mobile device that transmits and receives text-based messages. As used herein reference to a ‘text-based message’ means any type of information communicated via SMS format. Received messages are stored in memory of the wireless mobile device. Based on a privacy criteria stored in the memory, some of the received messages are automatically identified as public and others of the received messages are automatically identified as private. Access is provided to stored received messages that are designated as public to any user of the mobile device. Access is provided to stored received messages that are designated as private only after receipt of a password entered by a user of the wireless mobile device that permits access to the privately identified messages.

Another exemplary embodiment of the invention includes the wireless mobile device that substantially implements the above method.

A further exemplary embodiment of the invention includes an article with computer readable instructions that substantially implement the above method.

### DESCRIPTION OF THE DRAWINGS

Features of exemplary implementations of the invention will become apparent from the description, the claims, and the accompanying drawings in which:

FIG. 1 is a block diagram of an exemplary system suited for support of a mobile device that incorporates an embodiment of the present invention.

FIG. 2 is a block diagram of an exemplary wireless mobile device in accordance with an embodiment of the present invention.

FIG. 3 is a functional view of the system of the wireless mobile device in which privacy is provided in accordance with an embodiment of the present invention.

FIG. 4 is a view of a representative screen of the wireless mobile device showing an exemplary private contact screen in accordance with the present invention.

FIG. 5 is a view of a representative screen of the wireless mobile device showing an exemplary public contact screen.

FIG. 6 is a view of exemplary confidential information stored in the private contact database in accordance with the present invention.

FIG. 7 shows exemplary steps of an embodiment of a method for creating or editing confidential information stored in the private contact database in accordance with the present invention.

FIG. 8 shows exemplary steps of an embodiment of a method for controlling the storage of incoming messages in a private and/or public inbox in accordance with the present invention.

FIG. 9 shows exemplary steps of an embodiment of a method for controlling the storage of outbound messages in a private and/or public inbox in accordance with the present invention.

### DETAILED DESCRIPTION

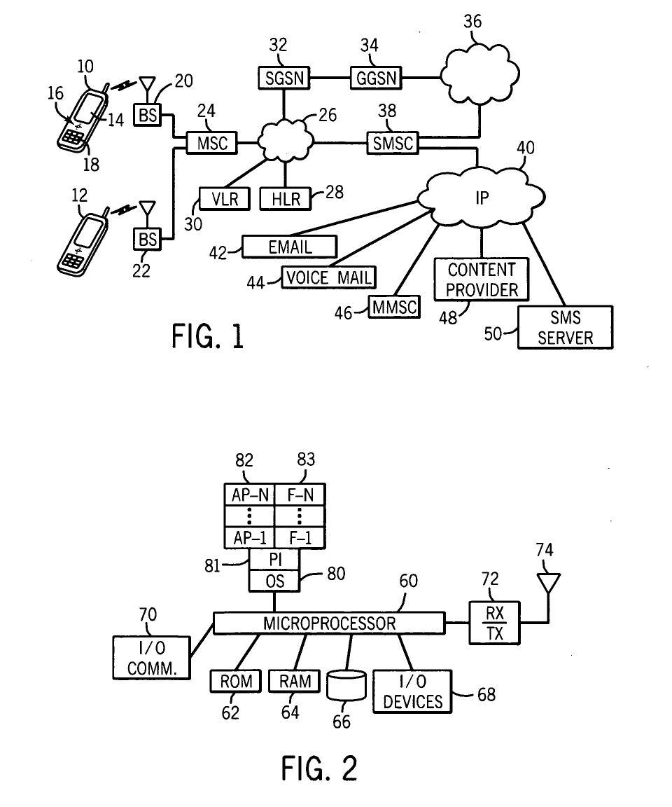

Referring to FIG. 1, an exemplary telecommunication network includes a system that supports wireless cellular subscribers with voice communications, multimedia message service (MMS), email and/or SMS messaging. First and second subscribers utilize mobile devices 10 and 12 such as a cellular telephone with these capabilities. As used herein, a mobile device means a wireless portable SMS capable two-way communications apparatus intended to be held in one hand during normal operation, e.g. a cellular telephone or personal digital assistant (PDA), and does not include a laptop computer. Each exemplary mobile device includes a display screen 14, user input controls 16 associated with cursor and screen control, and a keypad and/or keyboard 18 for accepting additional user inputs.

The system includes base stations (BS) 20 and 22 that support wireless communications between the devices 10 and 12, respectively, as controlled by a mobile switching center (MSC) 24. Signaling and data information are carried to and from the MSC by a supporting communication system 26, e.g. signaling system 7 (SS7). Also coupled to the system 26 is a home location register (HLR) 28 and a visiting location register (VLR) 30 which facilitate registration, authentication and location information related to the mobile devices.

In this illustrative example, communications are provided by a general public radio service (GPRS). Accordingly, communications with a serving GPRS service node (SGSN) 32 is also supported by system 26. Communications between the SGSN 32 and other networks 36, e.g. public switched telephone network (PSTN), general services mobile (GSM) network or code division multiple access (CDMA) network, is facilitated by a gateway GPRS service node (GGSN) 34.

A SMS controller (SMSC) 38 is coupled to system 26 and supports SMS communications among the mobile devices 10/12 and other devices which may be coupled to the internet protocol (IP) network 40. The mobile devices 10/12 may also support other communication services such as MMS, email, a browser for internet access, and/or other data applications. A variety of services, functions and apparatus may be connected to the network 40. For example, servers or other appropriate nodes may provide email service 42 and voice mail service 44 for the mobile devices. A multimedia message service center (MMSC) 46 may provide support for multimedia communications, e.g. pictures or video information. A content provider server 48 is merely illustrative of the many possible sources of information which are available over the Internet. An SMS server 50 provides an interface between communications utilizing the SMS protocol and other communication protocols such as packets transmitted over the Internet.

FIG. 2 is a block diagram of an illustrative embodiment of a mobile device, e.g. mobile device 10. The functionality of the mobile device is provided by microprocessor 60 which is supported by read-only memory (ROM) 62, random access memory (RAM) 64, and nonvolatile memory 66 such as flash memory, EEPROM, etc. Input/output (I/O) devices 68 may include input devices such as a keypad, keyboard, touchpad, and other buttons such as for cursor movement, screen selection, etc., microphone, and an input port jack for wire-based communications with other devices. The output devices include a display screen 14 and a speaker. A separate microprocessor (not shown) can be dedicated to rendering the video display if the computational load for creating images is too high for the primary microprocessor 60 to handle in addition to the other demands. An input/output communication module 70 supports two-way communications between the microprocessor 60 and external devices such as connected by a cable to the input port jack, by infrared (IR) beam, or by Bluetooth technology. A transmit and receive module 72 coupled to antenna 74 provides radio frequency (RF) communication support with base stations and/or other wireless devices such as by Wi-Fi. The microprocessor 60 operates under the control of an operating system (OS) 80 which provides basic operational functionality, e.g. exemplary operating systems are or are used in products by: Symbian, Windows Mobile, Palm, Research In Motion (RIM), iPhone, etc. The OS supports application programs 82 that provide higher-level functionality, files 83 that may contain various user information, and privacy interface (PI) application 81. The microprocessor in combination with associated memory and other peripheral devices form a microprocessing unit.

The PI application 81 functions as “middleware”, i.e. software that provides an interface between the OS and the higher level applications 82 and files 83. The PI application 81 enables the user to create a first group of certain selected applications 82 and files 83 that can be accessed only after the entry of a predetermined password (privacy protected) while permitting applications and files not within the first group to be accessed without the need for the entry of the password (public or not privacy protected). The same valid password operates to protect all of the applications/files that are privacy protected. The PI function also includes encryption functionality that is integrated with the text messaging capability of the mobile device. The PI function can also be incorporated within the OS. Middleware as defined herein refers to its supported functions whether disposed intermediate to the applications and the OS, or incorporated within the OS itself.

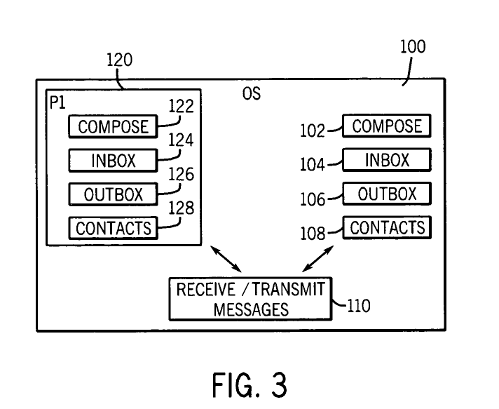

FIG. 3 shows a conceptual view of several features of an operating system (OS) 100 that supports a wireless mobile device. The operating system includes public functions associated with the generation, reception, transmission and storage of messages. A public compose function 102 provides the user with an interface to select the addressees to receive a message originated from the device as well as permitting the user to input the body of the message itself. The public inbox 104 provides for the storage and display of received messages from others that are listed as public contacts which each message may be stored as an individual record. The public outbox 106 provides for the storage and display of messages that have been transmitted or have been composed for transmission to another listed as a public contact where each message may be stored as an individual record. The public contacts function 108 stores and displays names and address information, e.g. telephone numbers, for people designated as public contacts for which the user on the subject mobile device has or expects to have future communications. Functions 102, 104, 106 and 108 are linked to files/records stored in the device that are public, i.e. anyone such as a guest user operating the device has access to this stored information. A receive/transmit message function 110 provides an interface between the functions 102, 104, 106 and 108, and the receiver/transmitter of the mobile device. The function 110 facilitates the formatting of information to be transmitted from the mobile device into a form suitable to be conveyed from the compose or outbox to the transmitter and formats the information obtained from the receiver into a format suitable to be transferred to the inbox.

The privacy interface application 120 includes private compose 122, private inbox 124, private outbox 126 and private contacts 128 functions that support similar functionality as described above for the corresponding functions 102, 104, 106 and 108 except that privacy is provided, i.e. access to these functions and stored information associated with these functions is only available to a user, e.g. the owner, who enters a required password. This “privacy password” is required for access to the PI application and its functions, but is not needed in order for a user to access public information on the device and perform public functions. Further the privacy password is not to be confused with a “keylock” password or similar password which is typically utilized to lock all functions of the device thereby making the device inoperable. The functions 122-128 also provide additional capabilities, as will be described below, beyond that provided by the corresponding functions 102, 104, 106 and 108. The receive/transmit message function 110 also provides an interface between the functions 122, 124, 126 and 128, and the receiver/transmitter of the mobile device.

An application programming interface (API) is available for the operating system of many wireless mobile devices (enhanced cellular telephones) which facilitates access by external applications to information stored under the control of the operating system and calling conventions permitting supported commands to be communicated between the application program and the operating system. The PI application utilizes the API interface to provide enhanced functionality as explained below for the user of the wireless mobile device. For example, a Blackberry manufactured by Research in Motion provides an API.

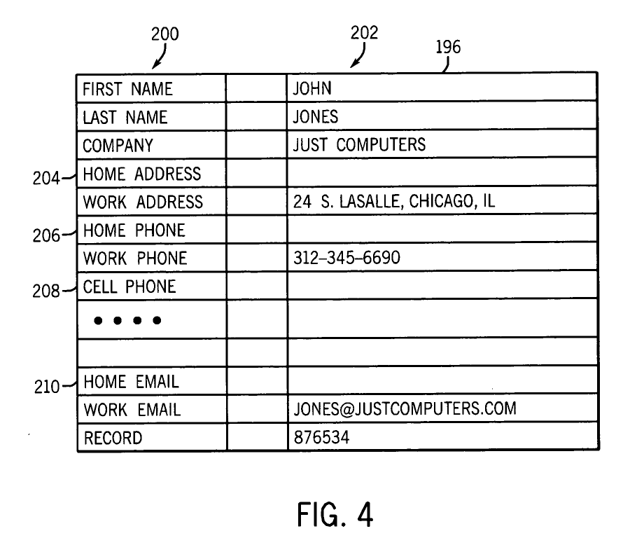

FIG. 4 shows a representative screen of the wireless mobile device showing an exemplary public contact screen 196. As used herein reference to one of the types of public screens refers to a screen and the display of corresponding stored data accessed from a corresponding public function which does not require the entry of the privacy password via the PI application to gain access to the function. The exemplary screen 196 includes a column 200 that contains a label or description of information stored in column 202. In this example, stored data is displayed in column 202 for the first name, last name, company, work address, work phone, work e-mail and record. This stored data has been input by the user in the public database/file as being public meaning that any person using the device can cause the public contact screen 196 to be displayed and upon selecting the record for John Jones will see the stored public data as shown in FIG. 4. The number displayed in the record field is typically assigned by the function upon creation of the record and is unique to stored information/records associated with “John Jones”.

It will be noted that the home address 204, home phone 206, cell phone 208 and home e-mail 210 fields display no corresponding data. The lack of displayed data for a particular field in public screen 196 does not necessarily mean that no corresponding data is available. It may be that no corresponding data has been stored for that field. However the display of no corresponding data in the public screen may be because this data has been stored by the user but designated as confidential as will be explained below.

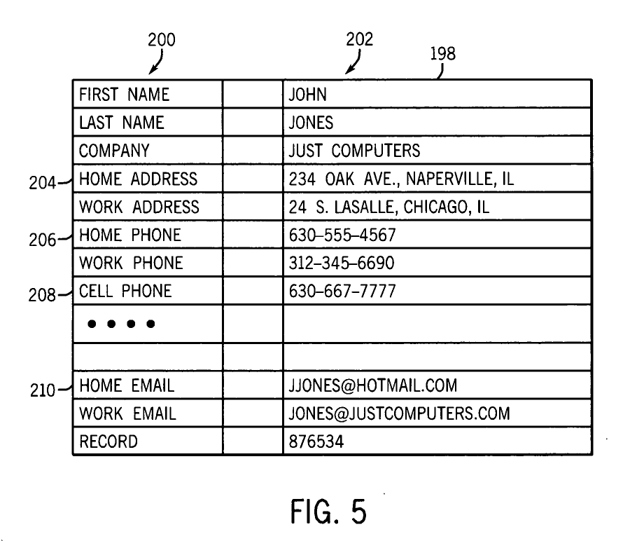

FIG. 5 is a view of a representative screen of the wireless mobile device showing an exemplary private contact screen 198. As used herein reference to a private screen refers to a screen and the display of corresponding stored data accessed from a corresponding private function (database) which requires the entry of the privacy password via the PI application to gain access to the function. Private contact screen 198 contains in this example the same description fields in column 200 as in column 200 of the public screen 196. In addition to displaying the same public data as shown in FIG. 4, stored confidential data is also displayed in the private contact screen for home address 204, home phone 206, cell phone 208 and home e-mail 210. In order to access the private contact function 128 contained in the PI application 120, the user will have been required to enter and have validated the password required to access and open the functions contained in the PI application. Alternatively, the private contact screen may contain additional description fields and corresponding stored confidential data, neither of which is displayed for a corresponding public record when accessed from the public screen function. The same number shown in the record field for both the public and private screens identifies corresponding records for the same entry as will be explained below. The private contact database may contain some private contact members that are exclusively within the private contact database, i.e. such private contact members are present in the private contact database and will be shown in a list of members on the private contact screen, but are not present in the public contact database and will not be shown in a list of members on the public contact screen. However, from the private contact screen the user will have access to all contact information contained in the private and public contact databases.

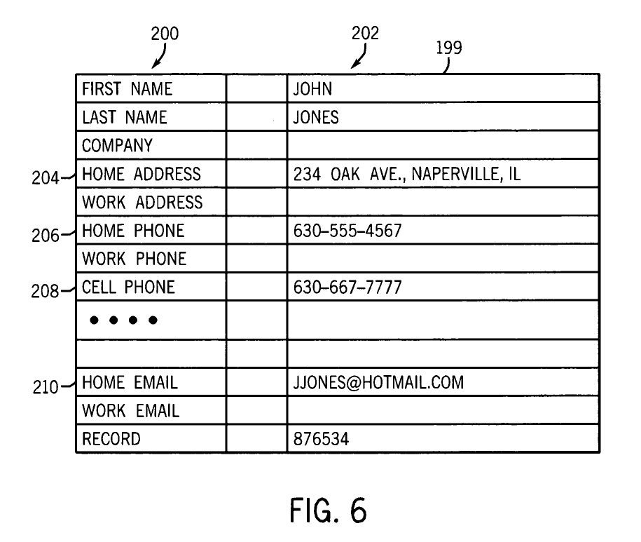

FIG. 6 is a view of information stored in a private record 199 in the private contact database in accordance with the present invention. The record 199 may contain only confidential information that would not be shown on access to the public records from the public contact screen. The purpose of record 199 is to store all of the confidential information for a corresponding contact entry, i.e. “John Jones”. However, in order to aid the linking of a private record with a corresponding public record for the same contact (person), some public information such as the first and last names, and record number may be duplicated within this private record. The public and private records may be stored in respective separate files in the database 66 where access to the file containing the private records is only permitted through functions contained in the PI application. Corresponding public and private records for the same entry can be identified by the same record number for each. For private contacts members that are exclusively within the contact database, all information for such contacts will be stored in the private database, and no corresponding information for such contacts will be stored in the public database. Hence, for such exclusive private members there will be no listing in the public contact screen or access to their information in the public database.

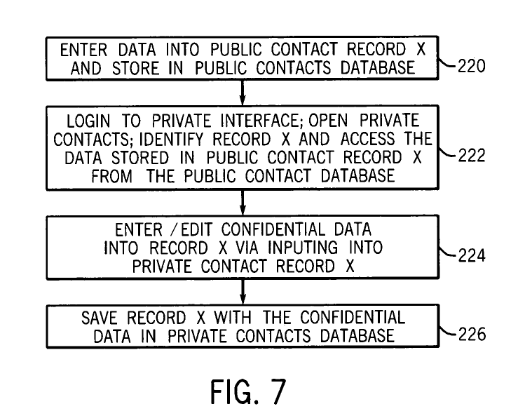

FIG. 7 shows exemplary steps of an embodiment of a method for creating and/or editing information stored in public and private records. In step 220 the user accesses the public contact records and enters data into public contact record X and stores the record in the public contacts database. It will be understood that the public and/or private databases referenced herein may be implemented in various ways including the use of a single physical database in which separate areas or files are used to store the respective public and private records/information. Because data is being entered into a public contact record, any user operating the device has access to this information. In step 222 the owner logs in to the PI application by the entry of a valid password and opens the private contacts function. The owner may then identify a desired entry to edit by scrolling through the existing records or may elect to create a new entry. In this example, the owner identifies an existing entry corresponding to record X and is provided with private access to this record. Private access includes displaying the record with the data stored in the public contact record X from the public contact database as well as any existing confidential data stored in the private contact record X from the private contact database. Preferably the confidential data is displayed with different indicia on the screen to differentiate it from the public data. For example, confidential data may be displayed in a different color, font or format then that used to display the public data. In step 224 the user edits and/or enters confidential data into record X by inputting the desired information into the private contact record X. In step 226 a user saves the private record X with the confidential data in the private contacts database.

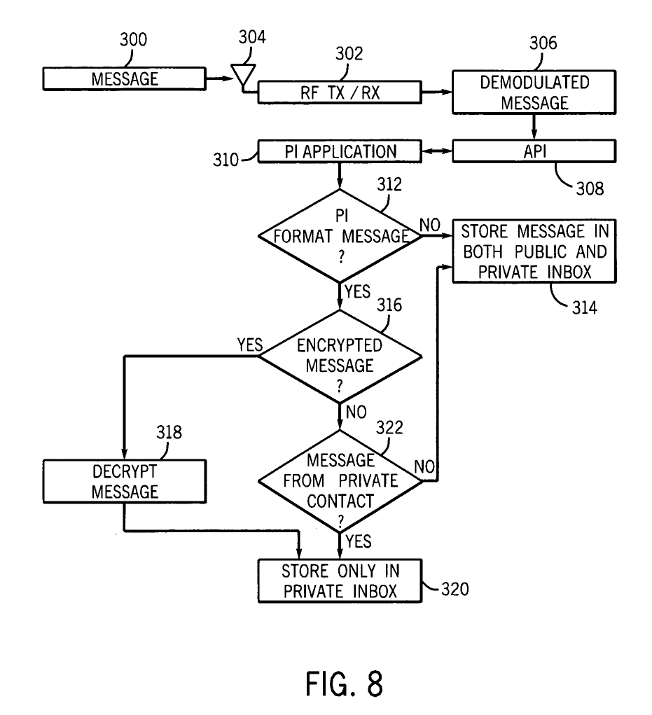

FIG. 8 shows exemplary steps of an embodiment of a method for controlling the storage of incoming (received) messages in a private and/or public inbox in accordance with the present invention. An incoming message 300 is received by the radio frequency (RF) transmitter/receiver (TX/RX) 302 via antenna 304 at a destination mobile device. In this illustrative example, the incoming message 300 is an SMS message. In step 306 the received message is demodulated from the RF air transmission format into a character-based format, e.g. ASCII characters. An application program interface (API) 308 provides an interface between the private interface application 310 and the character-based message. The below described decisions are performed by the PI application 310.

In step 312 a decision is made of whether the received character-based message is of a PI formatted type of message. For example, this determination may be based on whether a packet containing an incoming message contains a predetermined flag or symbol, e.g. “//PI” identifying the content of the message as being a PI formatted type of message. Preferably the predetermined flag or symbol is located in the packet at a predetermined location, e.g. a particular field in the header of the packet or at the beginning of the message content. A NO determination by step 312, indicating that the message is not a PI formatted type of message, results in the message being stored in both the public and private inbox as indicated at step 314.

A YES determination by step 312, indicating that the message is a PI formatted type of message, results in a determination by step 316 of whether the received message is encrypted utilizing the encryption capabilities of the PI application of the mobile device of the party that originated the message. A YES determination by step 316 results in the PI application of the mobile device of the receiving party decrypting the subject message at step 318 followed by storing the decrypted message only in the private inbox as indicated by step 320. In this example the receipt of an encrypted message is always treated as confidential and hence is stored only in the private inbox.

A NO determination by step 316 results in a determination of whether the unencrypted message has been received from an originating party designated as a private contact on the receiving party's mobile device at step 322. This determination may be implemented by comparing the originating party's name and/or label to the list of names/labels contained in the private contact database stored on the receiving party's mobile device, in which a match indicates that the received message is from a private contact. A NO determination by step 322, meaning that the received message is not from a private contact, results in the message being stored in both the public and private inboxes as indicated at step 314. A YES determination by step 322, indicating that the received message is from a private contact, results in the message being stored only in the private inbox at step 320. It will be apparent that references herein to the storage of messages in the public and/or private inbox refer to the storage of a message in a corresponding private and/or public database that is respectively accessed and displayed by the private and public inbox functions. Alternatively, both private and public messages maybe stored in a common database or file with designations stored with each message indicating which of the messages are private and public so that the public inbox will display only those messages designated as being public and the private inbox will display of private and public messages. If desired, a further determination can be made to determine if an originating party that is a public contact has designated an unencrypted message to be confidential. Confidential designation of such a message can be determined based on searching the content of the received message for a predetermined symbol or word, e.g. “confidential” in the subject line, etc. Such received messages designated as confidential can be saved only in the private inbox if desired.

This segregation of messages among the public and private inbox/received message database is advantageous to the owner of the mobile device. Because the received messages deemed to be confidential are accessible only from the private inbox, the owner of the mobile device can permit a guest user to operate the owner's mobile device without compromising the owner's privacy of the stored confidential messages since the guest user cannot access the private inbox to view the stored confidential, received messages. However, the guest user is allowed to access to the public inbox and view the non-confidential stored messages which may be useful to the guest user, e.g. finding relevant public information.

It is possible that the owner may receive a message that is automatically determined not to be confidential based on the above stated logic, and hence this message will be stored in both the public and private inbox. However, upon the owner's review of the subject matter or content of the message, it may be determined by the owner to be confidential. For example, a message may be received that does not have a PI format or that is a PI formatted message received from an originating party not on the list of private contacts, where the content of the message is desired to be maintain confidential by the owner. Preferably the owner is provided with an ability to select such a received message, e.g. by a pointing user interface, and to be presented with a pop-up screen by which the owner may manually elect a displayed command, e.g. “force confidential”, that will force the message to be considered as confidential. This action will cause the manually designated confidential message to remain accessible from the private inbox, but will prevent it from being accessible from the public inbox, e.g. a copy of the subject message can be deleted from the public inbox database or the state of a flag stored with the subject message record designating its inbox accessibility can be changed to designate the record as being accessible only from the private inbox.

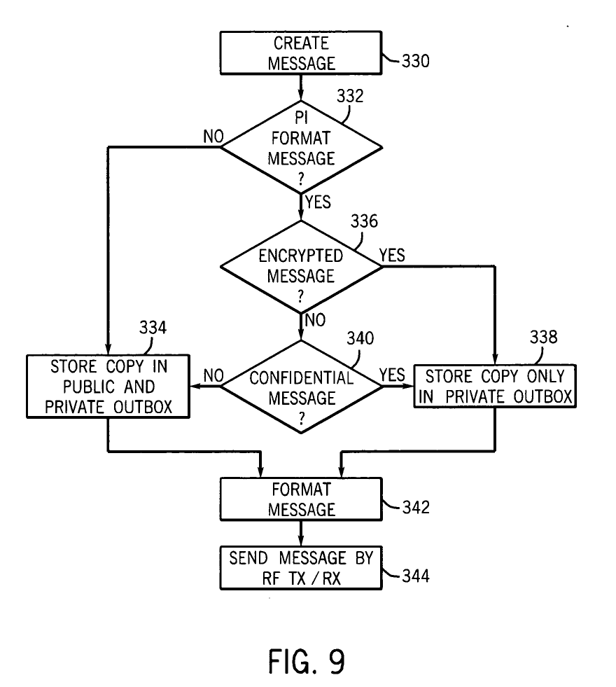

FIG. 9 shows exemplary steps of an embodiment of a method for controlling the storage of outbound (sent) messages in the private and/or public inbox. In step 330 the user creates a message, e.g. an SMS text message, using either the public compose screen are the private compose screen. In step 332 a determination is made of whether the created message has a PI format, i.e. whether the message was created in the private compose screen. A NO determination by step 332 results in the message being copied to both the public and private outbox for storage at step 334. A YES determination by step 332 results in a determination at step 336 of whether the message is to be transmitted as an encrypted message. A YES determination by step 336 results in the message being copied for storage only to the private outbox. In this illustrative example it is predetermined that all messages transmitted with encryption are to be considered confidential.

A NO determination by step 336 results in a determination in step 340 of whether the message to be transmitted is to be considered a confidential message, e.g. whether the message is addressed to a recipient for which a listing exists in the private contact database and a listing for this recipient is not found in the public contact database. Alternatively, the user may elect to have an outbound message determined to be confidential if a listing exists for the recipient in the private contact database regardless of whether a listing for the recipient also exists in the public contact database. A YES determination by step 340, indicating that the message is to be considered confidential, results in step 338 storing a copy of the message only in the private outbox. A NO determination by step 340, indicating that the message is not to be considered confidential, results in a copy of the message being stored both in the public and private outbox. With the message being stored only in the private outbox per step 338 or in both the public and private outbox per step 334, the character-based message is formatted in step 342 into a form suitable to be modulated and sent by the RF TX/RX module of the mobile radio at step 344.

This segregation of sent messages among the public and private outbox/sent message database is advantageous to the owner of the mobile device. Because the sent messages deemed to be confidential are accessible only from the private outbox, the owner of the mobile device can permit a guest user to operate the owner's mobile device without compromising the owner's privacy of the confidential sent messages since the guest user cannot access the private outbox to view the stored confidential, sent messages. However, the guest user is allowed to access the public outbox and view the non-confidential sent messages which may be useful to the guest user.

It is possible that the owner may send a message that is automatically determined not to be confidential based on the above stated logic, and hence this message will be stored in both the public and private outbox. However, upon the owner's further consideration of the subject matter or content of the message, it may be determined by the owner to be confidential. For example, a message may be sent that does not have a PI format or that is a PI formatted message sent to an addressee not on the list of private contacts, where the content of the message is desired to be maintain confidential by the owner. Preferably the owner is provided with an ability to select such a sent message, e.g. by a pointing user interface, and to be presented with a pop-up screen by which the owner may manually elect a displayed command, e.g. “force confidential”, that will force the message to be considered as confidential. This action will cause the manually designated confidential message to remain accessible from the private outbox, but will prevent it from being accessible from the public outbox, e.g. a copy of the subject message can be deleted from the public outbox database or the state of a flag stored with the subject message record designating its outbox accessibility can be changed to designate the record as being accessible only from the private outbox.

The mobile device in one example employs one or more computer-readable signal-bearing tangible media. The computer-readable signal-bearing media store software, firmware and/or assembly language for performing one or more portions of one or more embodiments of the invention. The computer-readable signal-bearing medium for the mobile device in one example comprises one or more of a magnetic, electrical, optical, biological, and atomic data storage tangible medium. For example, the computer-readable signal-bearing medium may comprise random access memory, flash drives and other forms of electronic, magnetic or optical memory.

Although exemplary implementations of the invention have been depicted and described in detail herein, it will be apparent to those skilled in the art that various modifications, additions, substitutions, and the like can be made without departing from the spirit of the invention. Various hardware, software, firmware, and combinations thereof can be used to implement the functionality and characteristics described herein in a wireless mobile device. The steps can be performed in a different order or combined, and some steps can be omitted depending on the desired results of the method.

The scope of the invention is defined in the following claims.

We claim:

1. A method implemented by a wireless mobile device for transmitting and receiving text-based messages, the method comprising the steps of:
storing received messages in memory of the wireless mobile device;
automatically identifying, based on a privacy criteria stored in the memory, some of the received messages as public and others of the received messages as private;
providing access to stored received messages that are designated as public to any user of the mobile device;
providing access to stored received messages that are designated as private only after receipt of a password entered by a user of the wireless mobile device that permits access to the privately identified messages.

2. The method of claim 1 wherein the step of identifying comprises the step of determining whether a received message has a first predetermined format identifying the message as having been originated from another device having private message encoding capability.

3. The method of claim 1 wherein a received message is identified as being private upon determining the received message originated from another device having an owner that is one contact in a list of private contacts stored on the wireless mobile device.

4. The method of claim 2 wherein upon determining that a received message has a first predetermined format identifying the message as having been originated from another device having private message encoding capability, determining a received message is private upon determining the received message originated from another device having an owner that is one contact in a list of private contacts stored on the wireless mobile device.

5. The method of claim 3 further comprising the mobile device storing two contact lists, one list being a list of private contacts and the other list being a list of public contacts that are not private contacts.

6. The method of claim 1 wherein the privacy criteria is stored in a privacy interface program that interfaces with an operating system of the mobile device, the steps of identifying and providing access to the private stored received messages being implemented by the privacy interface program.

7. The method of claim 1 wherein the steps of providing access includes providing access to the display on a screen of the mobile device of the stored received messages.

8. A tangible signal-bearing media readable by a wireless mobile device for transmitting and receiving text-based messages, the media comprising:
means in the media for storing received messages in memory of the wireless mobile device;
means in the media for automatically identifying, based on a privacy criteria stored in the memory, some of the received messages as public and others of the received messages as private;
means in the media for providing access to stored received messages that are designated as public to any user of the mobile device;
means in the media for providing access to stored received messages that are designated as private only after receipt of a password entered by a user of the wireless mobile device that permits access to the privately identified messages.

9. The media of claim 8 wherein the means in the media for identifying comprises means in the media for determining whether a received message has a first predetermined format identifying the message as having been originated from another device having private message encoding capability.

10. The media of claim 8 wherein a received message is identified as being private upon determining the received message originated from another device having an owner that is one contact in a list of private contacts stored on the wireless mobile device.

11. The media of claim 9 wherein upon determining that a received message has a first predetermined format identifying the message as having been originated from another device having private message encoding capability, means in the media for determining a received message is private upon determining the received message originated from another device having an owner that is one contact in a list of private contacts stored on the wireless mobile device.

12. The media of claim 10 further comprising the mobile device storing two contact lists, one list being a list of private contacts and the other list being a list of public contacts that are not private contacts.

13. The media of claim 8 wherein the privacy criteria is stored in a privacy interface program that interfaces with an operating system of the mobile device, the means in the media for identifying and providing access to the private stored received messages being implemented by the privacy interface program.

14. The media of claim 8 wherein the means in the media for providing access includes means in the media for providing access to the display on a screen of the mobile device of the stored received messages.

15. A wireless mobile device that transmits and receives text-based messages comprising:
memory that stores public contacts, private contacts, a privacy criteria and received messages;
a screen that displays information to a user;
means for accepting user inputs;
microprocessing unit automatically identifies, based on the privacy criteria, some of the received messages as public and others of the received messages as private;
the microprocessing unit providing access to stored received messages that are designated as public to any user of the mobile device;
the microprocessing unit prohibiting access to stored received messages that are designated as private until receipt of a password entered by a user of the wireless mobile device that permits access to the privately identified messages.

16. The wireless mobile device of claim 15 wherein the microprocessing unit identifies a received message as being private upon determining the received message originated from another device having an owner that is one contact in the private contacts stored on the wireless mobile device.

17. The wireless mobile device of claim 15 wherein the microprocessing unit determines that a received message has a first predetermined format identifying the message as having been originated from another device having private message encoding capability, the microprocessing unit determining a received message is private upon determining the received message originated from another device having private message encoding capability and having an owner that is one contact in a list of private contacts stored on the wireless mobile device.

18. The wireless mobile device of claim 15 wherein the privacy criteria is stored in a privacy interface program that interfaces with an operating system of the mobile device, the microprocessing unit identifying and providing access to the private stored received messages under the control of the privacy interface program.

19. The wireless mobile device of claim 1 wherein the microprocessing unit controls the display of received messages on the screen.
